(19) United States
(12) Patent Application Publication
(10) Pub. No.: US 2020/0157673 A1
(43) Pub. Date: May 21, 2020

(54) Suspension Plasma Spray Apparatus and Use Methods

(71) Applicant: United Technologies Corporation

(72) Inventors: Brian T. Hazel, Avon, CT (US); Jessica L. Serra, Vernon, CT (US); Xuan Liu, Glastonbury, CT (US)

(21) Appl. No.: 16/773,098

(22) Filed: Jan. 27, 2020

Related U.S. Application Data
(62) Division of application No. 14/993,582, filed on Jan. 12, 2016.

(51) Int. Cl. C23C 4/134; C23C 4/11; B05B 7/22

(52) U.S. Cl. CPC C23C 4/134; B05B 7/222; C23C 4/11

(57) ABSTRACT

A plasma spray gun has: a plasma outlet having an axis; and a plurality of liquid feedstock outlets having a non-uniform distribution about said axis.

### CROSS-REFERENCE TO RELATED APPLICATION

This is a divisional application of U.S. patent application Ser. No. 14/993,582, filed Jan. 12, 2016, and entitled “Suspension Plasma Spray Apparatus and Use Methods”, the disclosure of which is incorporated by reference herein in its entirety as if set forth at length.

### BACKGROUND

The disclosure relates to suspension plasma spray. More particularly, the disclosure relates to liquid feedstock suspension and solution plasma spray guns.

Suspension plasma spray (SPS) is a form of plasma spray wherein a particulate suspended in a carrier liquid is delivered to the plasma spray gun. In solution plasma spray, a solution is delivered to the gun. These liquid feedstock methods may be distinguished, for example, from other systems wherein powder is fed directly into the gun to interact with plasma and any residual carrier gas or from non-powder systems (e.g., wire systems).

One recent SPS proposal is in U.S. patent application Ser. No. 14/735,211, filed Jun. 10, 2015, and entitled “Suspension Plasma Spray Apparatus and Use Methods”, the disclosure of which is incorporated by reference in its entirety herein as if set forth at length.

FIG. 1 is an end view of an outlet of a baseline suspension plasma spray gun 20 having a plasma torch or gun 21. A plasma outlet 22 in a body 23 of the plasma torch 21 is shown having an axis (central longitudinal axis or centerline) 500 and oriented to discharge a plasma out from the plane of the drawing, i.e., along axis 500. A suspension outlet 24 in a nozzle 25 is oriented facing radially inward with its axis 502 intersecting the axis 500 to discharge a suspension flow (stream) 522 to be entrained by the plasma flow.

FIG. 2 is an end view of an outlet of a modified suspension plasma spray gun 29. To increase suspension flow, two suspension outlets 24A and 24B in respective nozzles 25A and 25B are diametrically oppositely oriented facing radially inward with axes 502A and 502B (coaxial). The two suspension flows 522A and 522B are thus also diametrically opposed and coaxial.

### SUMMARY

One aspect of the disclosure involves a plasma spray gun comprising: a plasma outlet having an axis; and a plurality of liquid feedstock outlets having a non-uniform distribution about said axis.

In one or more embodiments of any of the foregoing embodiments, the plurality of liquid feedstock outlets have a distribution that averages off the axis.

In one or more embodiments of any of the foregoing embodiments, the plurality of liquid feedstock outlets have a distribution that averages along the axis.

In one or more embodiments of any of the foregoing embodiments, the plurality of liquid feedstock outlets are each configured to dispense a suspension in a direction toward the axis.

In one or more embodiments of any of the foregoing embodiments, the plurality of liquid feedstock outlets comprises a pair of liquid feedstock outlets spaced by a nonzero angle of less than 45° about said axis.

In one or more embodiments of any of the foregoing embodiments, the pair of liquid feedstock outlets are formed by respective orifice pieces mounted in a shared body.

In one or more embodiments of any of the foregoing embodiments, the pair of liquid feedstock outlets have respective axes intersecting beyond the plasma outlet axis.

In one or more embodiments of any of the foregoing embodiments, the pair of liquid feedstock outlets have respective axes at an angle to each other smaller than said nonzero angle when viewed parallel to the axis.

In one or more embodiments of any of the foregoing embodiments, the pair of liquid feedstock outlets are at a single axial position relative to the plasma outlet.

In one or more embodiments of any of the foregoing embodiments: the pair is a first pair; and the plasma spray gun further comprises a second pair of liquid feedstock outlets wherein each liquid feedstock outlet of the second pair is diametrically opposite a corresponding liquid feedstock outlet of the first pair.

In one or more embodiments of any of the foregoing embodiments, the only liquid feedstock outlets are the first pair and the second pair.

In one or more embodiments of any of the foregoing embodiments, the angle is 10° to 45°.

In one or more embodiments of any of the foregoing embodiments, the angle is 20° to 35°.

In one or more embodiments of any of the foregoing embodiments, the only liquid feedstock outlets are the pair.

In one or more embodiments of any of the foregoing embodiments, plasma spray gun further comprises a third liquid feedstock outlet a nonzero angle from the pair of liquid feedstock outlets.

In one or more embodiments of any of the foregoing embodiments, plasma spray apparatus includes the plasma spray gun and further comprises a suspension or solution line coupled to the plasma spray gun.

In one or more embodiments of any of the foregoing embodiments, a suspension or solution supply coupled to the suspension or solution supply line.

In one or more embodiments of any of the foregoing embodiments, the suspension supply comprises ceramic particulate in an alcohol-based carrier.

In one or more embodiments of any of the foregoing embodiments, a carrier gas supply is coupled to the plasma spray gun.

In one or more embodiments of any of the foregoing embodiments, a power line is coupled to the plasma spray gun.

Another aspect of the disclosure involves a method for using the plasma spray gun. The method comprises: discharging a plasma from the plasma spray gun; and discharging suspension or solution flows from the plurality of liquid feedstock outlets to intersect the plasma.

In one or more embodiments of any of the foregoing embodiments, the method being used to apply a coating to a part wherein the part comprises a nickel-based superalloy substrate.

In one or more embodiments of any of the foregoing embodiments, the method is used to apply a coating to a part wherein: the part is a gas turbine engine component.

In one or more embodiments of any of the foregoing embodiments, the method is used to apply a coating to a part wherein: the coating is a stabilized zirconia.

Another aspect of the disclosure involves a plasma spray method using a plasma spray gun. The method comprises: discharging a plasma from a plasma outlet; and discharging a pair of liquid feedstock streams from a pair of liquid feedstock outlets, the liquid feedstock streams having a non-uniform distribution about an axis of the plasma.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic end view of an outlet of a first prior art suspension plasma spray gun.

FIG. 2 is a schematic end view of an outlet of a second prior art suspension plasma spray gun.

FIG. 3 is a schematic end view of an outlet of a first modified suspension plasma spray gun.

FIG. 4 is an end view of the outlet of the first modified suspension plasma spray gun.

FIG. 5 is a schematic end view of an outlet of a second modified suspension plasma spray gun.

FIG. 6 is a schematic end view of an outlet of a third modified suspension plasma spray gun.

FIG. 7 is a schematic end view of an outlet of a fourth modified suspension plasma spray gun.

FIG. 8 is a schematic view of a suspension plasma spray apparatus.

Like reference numbers and designations in the various drawings indicate like elements.

### DETAILED DESCRIPTION

FIG. 3 is an end view of an outlet of a modified suspension plasma spray gun 30. The two suspension outlets 24A and 24B are positioned along a small sector of the gun oriented facing radially inward. The exemplary sector is of an angle θ of 45° or less between the centers of the two outlets 24A and 24B, more particularly, 15° to 45°, or 20° to 40°. With the exemplary outlets 24A and 24B pointing radially inward (so that their centerlines 502A and 502B intersect the axis 500) an angle α between the centerlines 502A and 502B (when projected on a transverse plane) will be the same as θ. Exemplary values of α may be the same as those given for 6. An example where θ is different than α (e.g., injector centerlines do not meet at the axis 500) is discussed below in the context of FIG. 5.

The exemplary outlets 24A and 24B of FIG. 3 are oriented so that the centerlines 502A and 502B fall in a transverse plane. However, other implementations may incline the centerlines with a component parallel to the axis 500.

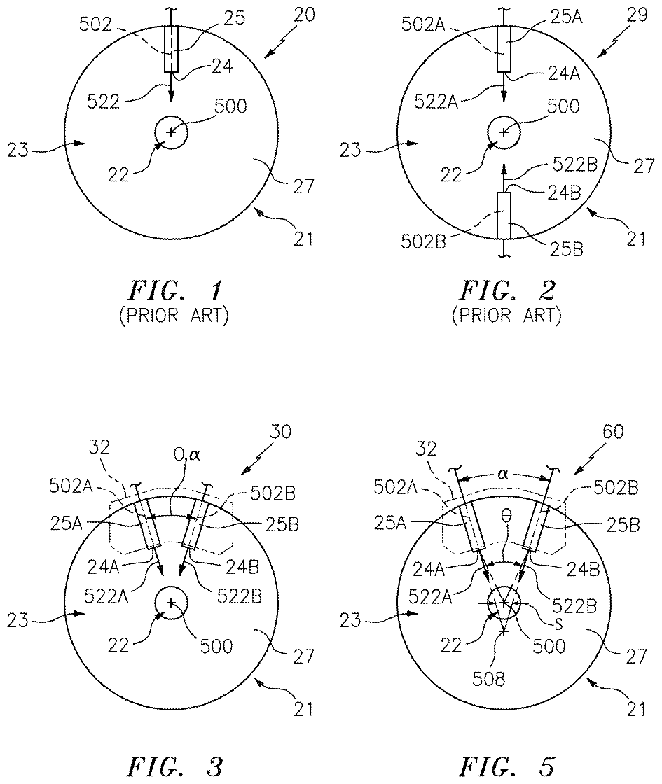

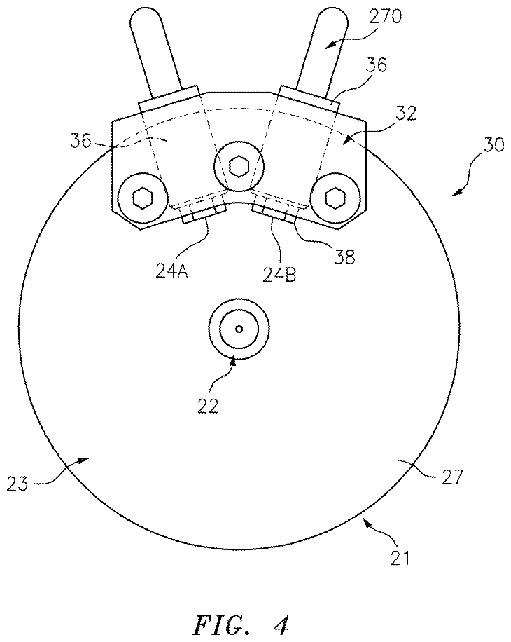

FIG. 3 shows the nozzles mounted on or in a single body 32. FIG. 4 shows further details where the nozzles each comprise a nozzle body mounted in the body 32 and bearing a separate orifice piece 38 (e.g., a screw-in orifice piece) which bears the associated outlet 24A or 24B (the orifice of the orifice piece). The use of two closely circumferentially spaced suspension outlets 24A and 24B and associated acute angles θ and α between the outlets and their discharged suspension flows (e.g., as shown in FIG. 3) may provide beneficial performance relative to a diametrically opposed pair of outlets (e.g., as shown in FIG. 2). This may result from a cooperation of the two closely spaced discharged suspension flows. Specifically, advantageous coating properties may be obtained by balancing the exposure of the suspension flow to the plasma (e.g., generally more is desirable) with achieving sufficiency of penetration of the plasma by the suspension flow without over penetration. Three effects which ultimately determine coating properties at the injection point that benefit from balancing the exposure are: (1) initial fragmentation; (2) fragment penetration and entrainment; and (3) particle melting.

Regarding the initial fragmenting, coating microstructure is strongly correlated to the initial contact of the liquid feedstock with the edge of the plasma plume, also known as the fragmentation event. A continuous liquid feedstock moving on the order of tens of m/s impinging on the edge of the plasma plume moving at hundreds of m/s creates primary liquid droplet fragments on the order of tens to hundreds of micrometers. As previous studies have shown (P. Fauchais, G. Montavon, R. S. Lima, B. R. Marple, “Engineering a new class of thermal spray nano-based microstructures from agglomerated nanostructured particles, suspensions and solutions: An invited review”, Journal of Physics D: Applied Physics, Volume 44, Issue 9, pages 1-53, IOP Publishing, Ltd., London, England, Feb. 15, 2011), optimal fragmentation is reached when the liquid momentum is slightly larger than momentum at the edge of the plasma. Geometrically, the liquid stream is then only in initial contact with a fraction of the surface area on the edge of the plasma (e.g., with the plasma represented by a cylindrical volume).

Regarding fragment penetration and entrainment, subsequently, liquid fragments with enough remaining momentum penetrate the plasma and are entrained which allows further fragmentation down to the size of a few micrometers or smaller during transit to the part. As is discussed below, both too much penetration and too little penetration are detrimental.

Regarding particle melting, also during transit, evaporation of the liquid fragments in the feedstock and melting of the spray particles occur.

The foregoing may be contrasted with merely increasing flow rate of a single injection point 24 of FIG. 1. To increase deposition efficiency, the mass flow rate at the single injection point can be increased. This, however, can be problematic in two ways. First, the increased volumetric flowrate is injected only into one sector of the plasma plume which does not have enough enthalpy to evaporate the liquid feedstock and/or melt the remaining ceramic particles. Second, the higher mass flowrate involves a liquid momentum which is much greater than the plasma momentum and becomes detrimental to fragmentation. The use of one high flow rate stream can overpower the plasma and induce fragments larger than previously noted which leads to poor microstructure. This may occur when the liquid penetrated to a high momentum core of the plasma or even more e.g. through the plasma entirely).

The use of two spaced-apart streams 522A and 522B versus a single stream of 522 twice the flow rate may decrease the liquid momentum of each stream (contrasted with a single larger stream) 522 relative to the plasma at their respective contact locations and allows optimal fragmentation to occur. Also, the spacing between liquid feedstock streams exposes the liquid feedstock to two different sectors of the plasma and increases the available amount of enthalpy for evaporation and particle softening or melting to occur.

Closely spacing the streams 522A and 522B may have a further benefit that is not otherwise immediately apparent. If two streams are close together, the streams will have an additive component to their momentum. This will result in deeper radial penetration into the plasma than might be achieved by diametrically opposed streams. Specifically, when two smaller mass flow rates are injected in close proximity of one another, such as in FIG. 3, the suspension streams are able to co-penetrate the plasma in two different volumes that may overlap from the outer diameter of the plasma to the core of the plasma. This effect allows for two streams to synergistically penetrate the plasma deeper than if they were diametrically opposed and maximizes penetration and entrainment of the fragmentations while retaining optimal fragmentation of two distinct streams. The net effect is an increased deposition rate without sacrificing optimal fragmentation and penetration. The improved fragmentation of having the increase exposure of two streams avoids the over-penetration that might occur with a single stream of equivalent momentum.

Aside from the poor fragmentation that results from having one high flow rate injection point, having a single injection point may result in over-penetration of the plasma as is noted above. A two-stream configuration may offer one or both of: 1) the increased surface area exposure described above; and 2) preventing or eliminating over-penetration into the plasma.

Compared to (contrasted with) a diametrically opposed injection (FIG. 2), the angle and spacing between two outlets 24A and 24B may be reduced (FIG. 3) to the point where optimal penetration of the plasma occurs while retaining proper fragmentation as described previously. Thus, under-penetration may be avoided. The exact angle may depend on the suspension parameters and the plasma parameters. In general, it may be advantageous to have angles in a range at or below 90° or, more particularly at or below 45° or at or below 35°. As a practical matter, lower limits may be influenced by the economics of suspension nozzle manufacture and/or avoiding suspension over-penetration depending on the parameters of the suspension and plasma. Various nozzle configurations and/or structures may impose minimum spacing between two adjacent nozzles (and thus may impose minimum angles at given radii away from the plasma axis 500). Exemplary lower ends on angle ranges may be 10° or 15° or 20°. Shadowgraph diagnostic tools may be used to determine the ranges of angles and separation at various flow rates to prevent over-penetration.

As mentioned above, the cooperation of the two flows may lead to other embodiments wherein the centerlines 502A and 502B do not intersect the axis 500 but intersect each other at a point away from the axis 500. FIG. 5 shows an example of a gun 60 where the centerlines intersect at a location 508 beyond the axis, thus θ is greater than a. This maintains both exposure and penetration. FIG. 5 shows a separation S of the centerlines at a transverse centerplane (containing the axis 500 but normal to a bisection of the angles θ and α). In some such embodiments, the difference in angle is effective to provide S as at least 10% of a diameter of the opening 22 (or other transverse dimension along said centerplane) or at least 20% or at least 25%. Upper limits, if desired may be 100% or 75%.

Additionally, the possibility exists for adding further suspension outlets. In general, these may be characterized as being at a non-uniform spacing about the plasma axis 500. In the FIG. 3-5 examples, the spacing is non-uniform in that the spacing from one outlet to the next in a given circumferential direction is not the same. For example, as one proceeds in one circumferential direction (clockwise in the illustrated numbering) from the outlet 24A of the nozzle 25A the spacing is by the angle θ; in the opposite direction the spacing between one outlet 24A and the next outlet 24B is by a different angle. Similarly, in these FIGS. 3-5 embodiments, the weighted or average distribution of outlets is not centered along the axis 500. Although the single outlet of FIG. 1 also by definition has an off-center average (off the axis 500) distribution, the multiple outlets of FIG. 2 average to the center (along the axis 500).

An even distribution or uniform distribution would include an exactly even or exactly uniform distribution plus those substantially even or substantially uniform such as within typical manufacturing and assembly tolerances of exactly even or uniform. A non-even or non-uniform distribution would be beyond this. For example, a non-even distribution might be associated with variation in outlet-to-outlet spacing of more than 5° or more than 10° or more than 20°. Similarly, a clearly off-center average would be associated with at least as great a departure as one would find if one eliminated an outlet from an otherwise evenly/uniformly distributed group of four outlets.

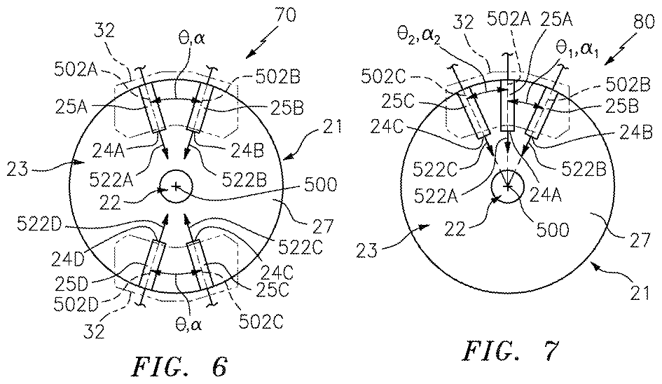

In one example of a gun 70 FIG. 6, a first pair of nozzles 25A and 25B may have associated outlets 24A and 24B as discussed above. An additional or second pair of nozzles 25C and 25D may be positioned elsewhere about the axis 500. In the particular FIG. 6 example, the second pair is diametrically opposite the first pair. Even though each nozzle may have a diametrically opposite counterpart, the close positioning of the two nozzles of each pair may achieve the foregoing benefits and thus the FIG. 6 example would have corresponding benefits over four otherwise identical nozzles at 90° intervals about the axis 500. The FIG. 6 embodiment thus also involves outlets at a non-uniform spacing. However, its distribution of outlets averages to the center.

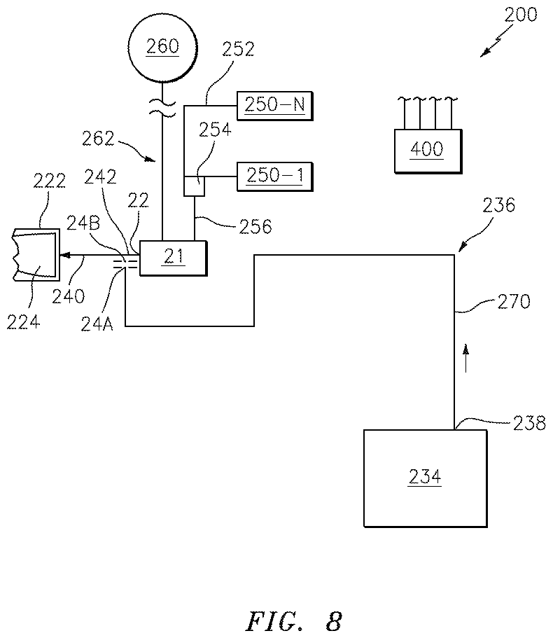

FIG. 7 shows an example of a gun 80 with three nozzles 25A, 25B, 25C with respective outlets 24A, 24B, 24C and angles θ1 and θ2 between adjacent outlets and α1 and α2 between adjacent axes 502A, 502B, 502C. Again, it is clearly seen that the FIG. 7 embodiment involves outlets at non-uniform spacing and an eccentric distribution.

The injection setup is not limited simply to a co-planar radially inward suspension stream and nozzle orientation. For example, another embodiment utilizing the effect in the plasma can be achieved with staggered injection points along the plasma axis (e.g., along axis 500). This may allow for more injection points than just placing injectors around the gun face 27. In one configuration, the injector axes 502A and 502B are pointed towards the axis 500. Yet other embodiments (not shown) may have the injector axes 502A and 502B pointed partially axially (i.e., with a component parallel to the axis 500) inward towards or outwards away from the gun face opening 22. Additional embodiments (not shown) that utilize the effect can combine elements of staggered, non-planar and radially inward injection. The features of the various embodiments may be recombined in other combinations. For example, the difference between θ and α of FIG. 5 may be applied to embodiments such as those of FIGS. 6 and 7.

FIG. 8 shows a suspension plasma spray (SPS) system 200 for applying a coating 222 to a workpiece 224 (e.g., a blade tip region shown). An alternative solution plasma spray system may be similarly configured. However, either system may reflect a wide variety of existing or yet-developed configurations. The workpiece 224 may be a gas turbine engine component such as a blade, vane, combustor panel, outer air seal, or the like. An exemplary workpiece includes a metallic substrate which may be formed of an exemplary alloy such as a nickel-based superalloy. The substrate may bear one or more additional coating layers which may be applied by SPS or other techniques (e.g., bond coats and the like). Exemplary coatings 222 are ceramic coatings. Exemplary ceramic coatings are zirconia-based coatings such as yttria-stabilized zirconia (YSZ) and gadolinia-stabilized zirconia (GSZ). Exemplary coatings are discharged as a spray 240 carried by plasma discharge 242 from the outlet 22 of the plasma gun 21.

The system 200 includes a suspension source 234. The exemplary source 234 may contain a reservoir of a mixture of coating particles and a liquid carrier suspending the particles. Other variations may involve mixing the particles and the carrier at the source 234. The suspension source 234 may include items such as: one or more pumps and/or gas sources (e.g., air, Ar, and/or N2) for pressurizing the suspension to drive suspension flow from the suspension source to the plasma gun 21; meters; sensors; valves; diagnostic hardware; and the like. As noted above, exemplary particles are of a ceramic such as a zirconia-based ceramic (e.g., at least 50% zirconia by weight). Exemplary liquid carrier is alcohol-based (e.g., at least 50% alcohol by weight).

A flowpath (suspension supply flowpath) 236 extends from an outlet 238 of the suspension source 34 to the suspension outlets 24A and 24B (and any others—not shown). The exemplary outlets 24A and 24B are external to the plasma gun 21 outlet 22. Thus, the suspension flow discharged from the outlets may mix with the plasma 242 and its carrier gas to be propelled as the spray 240. FIG. 8 shows plural gas sources 250-1 to 250-N of gases such as argon, helium, nitrogen, hydrogen, and the like as may be appropriate for the desired chemistry and physics of the particular plasma gun and suspension spray. The gas lines 250-1 to 250-N may have associated gas lines 252 and associated flowpaths extending to a mixer 254 which may include appropriate valves and the like for mixing the gases in desired proportions. A line 256 extends from the mixer 254 to the plasma gun 21. FIG. 6 further shows an electric power source 260 coupled to the plasma gun 21 by wiring 262 to provide energy for generating the plasma.

Alternative plasma gun configurations (not shown) may integrate the suspension supply line 270 into a gun body such that the mixing of the suspension with the plasma and carrier gas is internal to the gun (e.g., via internal outlets of each).

FIG. 8 further shows the suspension supply line 270 extending along the flowpath 236. One or more valves (not shown) may be located along the suspension supply line 270 and used for additional functions such as discussed below. The supply line and associated flowpath may branch out to feed the individual outlets.

This represents a basic system for performing SPS. Various other components (not shown), including one or more filters and/or vibrators may be located along the flowpath 236 to prevent agglomerates/large particles from plugging the orifices of the nozzles or building up in undesirable locations. Additional possible features include: a recirculation line/flowpath to recirculate suspension back to the source 234 to prevent stagnation of the suspension and associated clogging; vibrators along the line 270/flowpath 236 to prevent settling of suspended particulate; a water or solution source for purging; and an air or additional gas source for various functions including purging, powering vibrators, and the like. Examples of such features are seen in the aforementioned U.S. patent application Ser. No. 14/735,211.

FIG. 8 further shows a controller 400. The controller may receive user inputs from an input device (e.g., switches, keyboard, or the like) and sensors (not shown, e.g., pressure sensors, flow meters, temperature sensors, and the like at various system locations). The controller may be coupled to the sensors and controllable system components (e.g., valves, pumps, and the like) via control lines (e.g., hardwired or wireless communication paths). The controller may include one or more: processors; memory (e.g., for storing program information for execution by the processor to perform the operational methods and for storing data used or generated by the program(s)); and hardware interface devices (e.g., ports) for interfacing with input/output devices and controllable system components. In some embodiments, the controller 400 may be configured to control the suspension flow and distribution from the one or more outlets 24A, 24B as described herein.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing baseline configuration, details of such baseline may influence details of particular implementations. Accordingly, other embodiments are within the scope of the following claims.

What is claimed is:

1. A plasma spray gun comprising:
a plasma outlet having an axis; and
a plurality of liquid feedstock outlets having a non-uniform distribution about said axis.

2. The plasma spray gun of claim 1 wherein:
the plurality of liquid feedstock outlets have a distribution that averages off the axis.

3. The plasma spray gun of claim 1 wherein:
the plurality of liquid feedstock outlets have a distribution that averages along the axis.

4. The plasma spray gun of claim 1 wherein:
the plurality of liquid feedstock outlets are each configured to dispense a suspension in a direction toward the axis.

5. The plasma spray gun of claim 1 wherein:
the plurality of liquid feedstock outlets comprises a pair of liquid feedstock outlets spaced by a nonzero angle of less than 45° about said axis.

6. The plasma spray gun of claim 5 wherein:
the pair of liquid feedstock outlets are formed by respective orifice pieces mounted in a shared body.

7. The plasma spray gun of claim 5 wherein:
the pair of liquid feedstock outlets have respective axes intersecting beyond the plasma outlet axis.

8. The plasma spray gun of claim 5 wherein:
the pair of liquid feedstock outlets have respective axes at an angle to each other smaller than said nonzero angle when viewed parallel to the axis.

9. The plasma spray gun of claim 5 wherein:
the pair of liquid feedstock outlets are at a single axial position relative to the plasma outlet.

10. The plasma spray gun of claim 5 wherein:
the pair is a first pair; and
the plasma spray gun further comprises a second pair of liquid feedstock outlets wherein each liquid feedstock outlet of the second pair is diametrically opposite a corresponding liquid feedstock outlet of the first pair.

11. The plasma spray gun of claim 10 wherein:
the only liquid feedstock outlets are the first pair and the second pair.

12. The plasma spray gun of claim 5 wherein:
the angle is 10° to 45°.

13. The plasma spray gun of claim 5 wherein:
the angle is 20° to 35°.

14. The plasma spray gun of claim 5 wherein:
the only liquid feedstock outlets are the pair.

15. The plasma spray gun of claim 5 further comprising a third liquid feedstock outlet a nonzero angle from the pair of liquid feedstock outlets.

16. A plasma spray apparatus including the plasma spray gun of claim 1 and further comprising:
a suspension or solution line coupled to the plasma spray gun;
a suspension or solution supply coupled to the suspension or solution supply line;
a carrier gas supply coupled to the plasma spray gun; and
a power line coupled to the plasma spray gun.

17. A method for using the plasma spray gun of claim 1, the method comprising:
discharging a plasma from the plasma spray gun; and
discharging suspension or solution flows from the plurality of liquid feedstock outlets to intersect the plasma.

18. The method of claim 17 used to apply a coating to a part wherein:
the part comprises a nickel-based superalloy substrate.

19. The method of claim 17 used to apply a coating to a part wherein:
the part is a gas turbine engine component.

20. The method of claim 17 used to apply a coating to a part wherein:
the coating is a stabilized zirconia.

21. A plasma spray method using a plasma spray gun, the method comprising:
discharging a plasma from a plasma outlet; and
discharging a pair of liquid feedstock streams from a pair of liquid feedstock outlets, the liquid feedstock streams having a non-uniform distribution about an axis of the plasma.
